(19) United States
(12) Patent Application Publication
(10) Pub. No.: US 2011/0307460 A1
(43) Pub. Date: Dec. 15, 2011

(54) NAVIGATING RELATIONSHIPS AMONG ENTITIES

(75) Inventors: VISWANATH VADLAMANI, REDMOND, WA (US); TAREK NAJM, KIRKLAND, WA (US); ARUNGUNRAM CHANDRASEKARAN SURENDRAN, SAMMAMISH, WA (US)

(73) Assignee: MICROSOFT CORPORATION, REDMOND, WA (US)

(21) Appl. No.: 12/796,753

(22) Filed: Jun. 9, 2010

(51) Int. Cl. G06F 17/30

(52) U.S. Cl. 707/706; 707/769; 707/E17.108

(57) ABSTRACT

Graphical user interfaces, methods, and computer-storage media for navigating relationships among entities are provided. The method is executed by a computer system that generates a graphical user interface having entities associated with a query. The query is issued to a search engine that searches multiple sources to locate results. The computer system extracts the entities from the results. In turn, a graph is added to the graphical user interface to group the entities. The graph links the query and the entities and provides a visual overview of the results for the query.

### CROSS-REFERENCE TO RELATED APPLICATIONS

This application is related to MS# 328721.01/MFCP.153347, application Ser. No. 12/727,836, filed 19 Mar. 2010, entitled “Presenting Answers”; and MS# 329670.01/MFCP.154856, application Ser. No. 12/795,238, filed 7 Jun. 2010, entitled “Identifying Dominant Concepts Across Multiple Sources,”, and which are incorporated by reference herein.

### BACKGROUND

Conventional search engines receive queries from users and locate web pages having terms that match the terms included in the received queries. Conventionally, the search engines ignore the context and meaning of the user query and treat the query as a set of words. The terms included in the query are searched for based on frequency, and results that include the terms of the query are returned by the search engine. Accordingly, conventional search engines return results that might fail to satisfy the interests of the user.

The conventional search engines may display a set of popular terms that a user may employ to formulate a query. The popular terms are words that users provide the search engine when searching for an item. The popular terms may be displayed in a hot topics section on a web page for the search engine. A user may click on the popular terms listed in the hot topics section to issue a query with the selected popular term.

Some conventional search engines also display tag clouds that list terms that reoccur across all items on a network, such as the Internet. The tag clouds provide a snapshot of the words that are being used within items available on the Internet. The terms in the tag cloud may be displayed in a cluster on a web page for the search engine. And a user may click on the terms listed in the tag cloud to issue a query with the selected term.

Unfortunately, the conventional search engines fail to provide a broad overview of the entities that are encapsulated within the results provided in response to a user's query. Rather, in response to the user's query the conventional search engines return a collection of items that include the terms of the query. The user must then peruse the collection to identify entities represented in the collection of documents.

### SUMMARY

Embodiments of the invention relate to systems, methods, and computer-readable media that navigate entities corresponding to a query. A graphical user interface is generated to display the relationships among the entities and the query. The graphical user interface includes a graph for the entities extracted from multiple sources. The entities are extracted from results generated by a search engine that received the query. The relationships between the entities and query are displayed to provide a broad overview of the results.

A computer system executes a computer-implemented method to navigate the relationships among entities and query. The computer system generates a graphical user interface for the dominant concepts. The graphical user interface includes a graph that links the query and entities extracted from the search results for the query. The graph includes nodes and edges. The nodes represent the extracted entities and the query. The edges connect the query and extracted entities. A user may select or hover over the nodes to obtain additional information for the selected node or the node hovered over. Moreover, the user may alter the entities displayed on the graphical user interface by changing an entity selection algorithm implemented by the computer system.

This summary is provided to introduce a selection of concepts in a simplified form that are further described below in the detailed description. This summary is not intended to identify key features or essential features of the claimed subject matter, nor is it intended to be used as an aid in isolation to determine the scope of the claimed subject matter.

### BRIEF DESCRIPTION OF THE DRAWINGS

Illustrative embodiments of the invention are described in detail below with reference to the attached drawing figures, which are incorporated by reference herein, wherein:

FIG. 1 is a block diagram illustrating an exemplary computing device in accordance with embodiments of the invention;

FIG. 2 is a screenshot illustrating a graphical user interface displaying relationships among a query and its corresponding entities in accordance with embodiments of the invention;

FIG. 3 is a screenshot illustrating a query and its corresponding entities in accordance with embodiments of the invention;

FIGS. 4A and 4B are screenshots illustrating the highlight to edges and nodes that link the entities and query in accordance with embodiments of the invention;

FIG. 5 is another screenshot illustrating a nested node in accordance with embodiments of the invention;

FIGS. 6A and 6B are screenshots illustrating the highlight to nested nodes that link the entities and query in accordance with embodiments of the invention;

FIG. 7 is another screenshot illustrating a graphical user interface providing details for a selected relationship in accordance with embodiments of the invention;

FIG. 8 is another screenshot illustrating a graphical user interface providing details for an inner node of a nested node in accordance with embodiments of the invention;

FIG. 9 is another screenshot illustrating a graphical user interface providing a dropdown box to select an algorithm that selects the entities displayed on the graphical user interface in accordance with embodiments of the invention;

FIG. 10 is another screenshot illustrating a graphical user interface providing a history pane that displays previously selected nodes in accordance with embodiments of the invention; and

FIG. 11 is a logic diagram illustrating a computer-implemented method for navigating relationship among entities in accordance with embodiments of the invention.

### DETAILED DESCRIPTION

This patent describes the subject matter for patenting with specificity to satisfy statutory requirements. However, the description itself is not intended to limit the scope of this patent. Rather, the inventors have contemplated that the claimed subject matter might also be embodied in other ways, to include different steps or combinations of steps similar to the ones described in this patent, in conjunction with other present or future technologies. Moreover, although the terms “step” and “block” may be used herein to connote different elements of methods employed, the terms should not be interpreted as implying any particular order among or between various elements herein described unless and except when the order of individual elements is explicitly described.

As used herein the term “component” refers to any combination of hardware, firmware, and software.

Embodiments of the invention provide a graphical user interface that displays entities extracted from results associated with queries received by a search engine. The graphical user interface provides a visual representation of dominant relationships extracted from the search results. In one embodiment, entities in a corpus of documents included in the results are ranked and displayed to a user. The corpus of documents includes items from various sources searched by the search engine in response to the queries. Relationships between the entities and the queries are prioritized based on support from the corpus of documents. A user may explore entities with a pointer that clicks on the graph or a pointer that hovers over the graph. Moreover, the entities in the graph may be presented as query terms to the search engine by clicking on the displayed entities. The graphical user interface provides a history view that displays recent entities accessed by the user or recent queries formulated by the user.

In some embodiments, the dominant concepts within the corpus of documents may be navigated with a graph control. The graph may include nodes and edges, where the edges connect the nodes. The nodes represent the extracted entities and the query. The graphical user interface is always updated to illustrate the area of the graph that is in focus. In some embodiments, the graphical user interface automatically shifts the graph up, left, right, or down to display a selected node or hovered-over node with an appropriate level of focus.

For instance, a search engine may provide results in response to a query for “Microsoft Corporation.” The results of the search engine are further processed to identify entities and relationships between the extracted entities and the query terms. The entities for the “Microsoft Corporation” may include, but are not limited to, MSFT, Application Software, and Similar PE Ratio. These entities are ranked based on distances provided by a metabase having the entities and the contextual queries. In another embodiment, the rank may be based on an appearance frequency. The appearance frequency may be calculated based on appearance of the entity within the search results. Alternatively, the appearance frequency may be calculated based on appearance of the entity within the various sources searched by the search engine. In turn, the entities with the highest ranks are selected for display on a graphical user interface with the queries. The graphical user interface may display “Microsoft Corporation,” “MSFT,” “Application Software,” and “Similar PE Ratio” as linked nodes of a graph.

The user may navigate the graph with a mouse or any other pointing device. When the user hovers on the “Similar PE Ratio” entity a details section appears. The details section provides attribute information for the “Similar PE Ratio” entity. The attributes may include earning information, dividend information, ticker information, and price information for other stocks that have earnings ratios similar to Microsoft Corporations' earnings ratio.

The search engine receives query terms from a user. Various data sources are searched to locate results that match to the query. The results are further processed by a computer system to identify entities represented in the results. In some embodiments, the entities are nouns, phrases, adjectives, adverbs, etc. In one embodiment, the extracted entities are ranked and linked to the query when a distance between the extracted entities and the query is below a specified threshold. Moreover, the extracted entities having an appearance frequency over an appearance threshold are identified as dominant entities and the relationship between the query and the extracted entity are identified as dominant relationships.

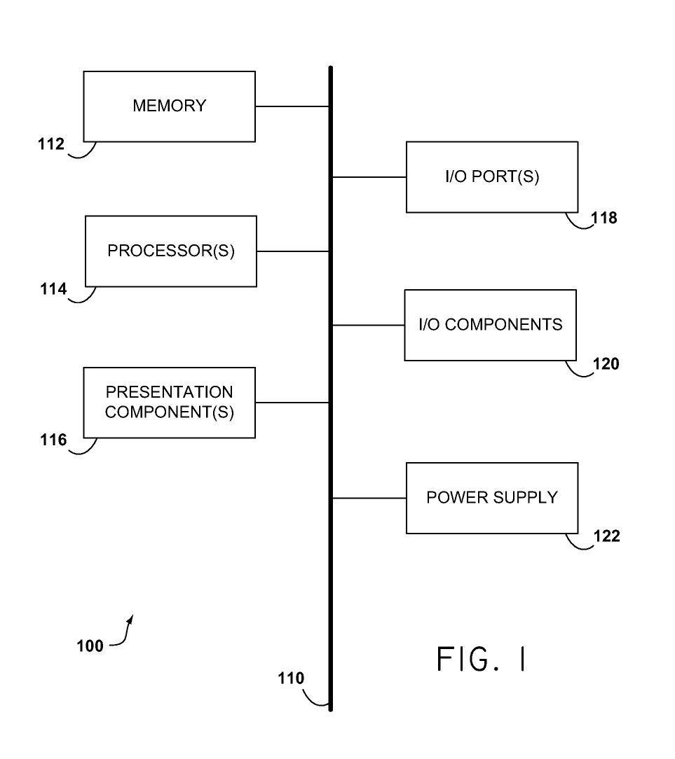

FIG. 1 is a block diagram illustrating an exemplary computing device in accordance with embodiments of the invention. The computing device 100 includes bus 110, memory 112, processors 114, presentation components 116, input/output (I/O) ports 118, input/output (I/O) components 120, and a power supply 122. The computing device 100 is but one example of a suitable computing environment and is not intended to suggest any limitation as to the scope of use or functionality of the embodiments of the invention. Neither should the computing device 100 be interpreted as having any dependency or requirement relating to any one or combination of components illustrated.

The computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, or any other medium that may be used to encode desired information and be accessed by the computing device 100. Embodiments of the invention may be implemented using computer code or machine-useable instructions, including computer-executable instructions such as program modules, being executed by a computing device 100, such as a personal data assistant, gaming device, or other handheld device. Generally, program modules including routines, programs, objects, modules, data structures, and the like, refer to code that performs particular tasks or implements particular abstract data types. Embodiments of the invention may be practiced in a variety of system configurations, including distributed computing environments where tasks are performed by remote-processing devices that are linked through a communications network.

The computing device 100 includes a bus 110 that directly or indirectly couples the following components: memory 112, one or more processors 114, one or more presentation modules 116, input/output (I/O) ports 118, I/O components 120, and power supply 122. The bus 110 represents what may be one or more busses (such as an address bus, data bus, or combination thereof). Although the various components of FIG. 1 are shown with lines for the sake of clarity, in reality, delineating various modules is not so clear, and metaphorically, the lines would more accurately be grey and fuzzy. For example, one may consider a presentation component 116 such as a display device to be an I/O component. Also, processors 114 have memory 112. Distinction is not made between “workstation,” “server,” “laptop,” “handheld device,” etc., as all are contemplated within the scope of FIG. 1.

The memory 112 includes computer-readable media and computer-storage media in the form of volatile and/or nonvolatile memory. The memory may be removable, nonremovable, or a combination thereof. Exemplary memory hardware includes, but is not limited to, solid-state memory, hard drives, optical-disc drives, etc. The computing device 100 includes one or more processors 114 that read data from various entities such as the memory 112 or I/O components 120. The presentation components 116 present data indications to a user or other device. Exemplary presentation components 116 include a display device, speaker, printer, vibrating module, and the like. The I/O ports 118 allow the computing device 100 to be physically and logically coupled to other devices including the I/O components 120, some of which may be built in. Illustrative I/O components 120 include a microphone, joystick, game pad, satellite dish, scanner, printer, wireless device, and the like.

In some embodiments, a computer system identifies dominant entities and relationships between the identified entities and a query. The computer system includes a search engine connected to various sources, an entity extraction component, a metabase, and a ranking component. The search engine receives a query and provides results in response to the query. The entity extraction component parses the results and identifies entities included in the results. The metabase provides a distance between the entities included in the results and the query terms included in the query. The ranking component ranks the entities based on the distance provided by the metabase and provides dominant entities within the results based on the ranks assigned to entities. In one embodiment, an entity is considered dominant when its appearance frequency is above a specified threshold, e.g., 200 appearances. In turn, relationships between the dominant entity and queries are also identified as dominant. The relationships are made available for navigation by the user via a graph. In other embodiments, the graph may be a cluster or any other aggregation of similar items.

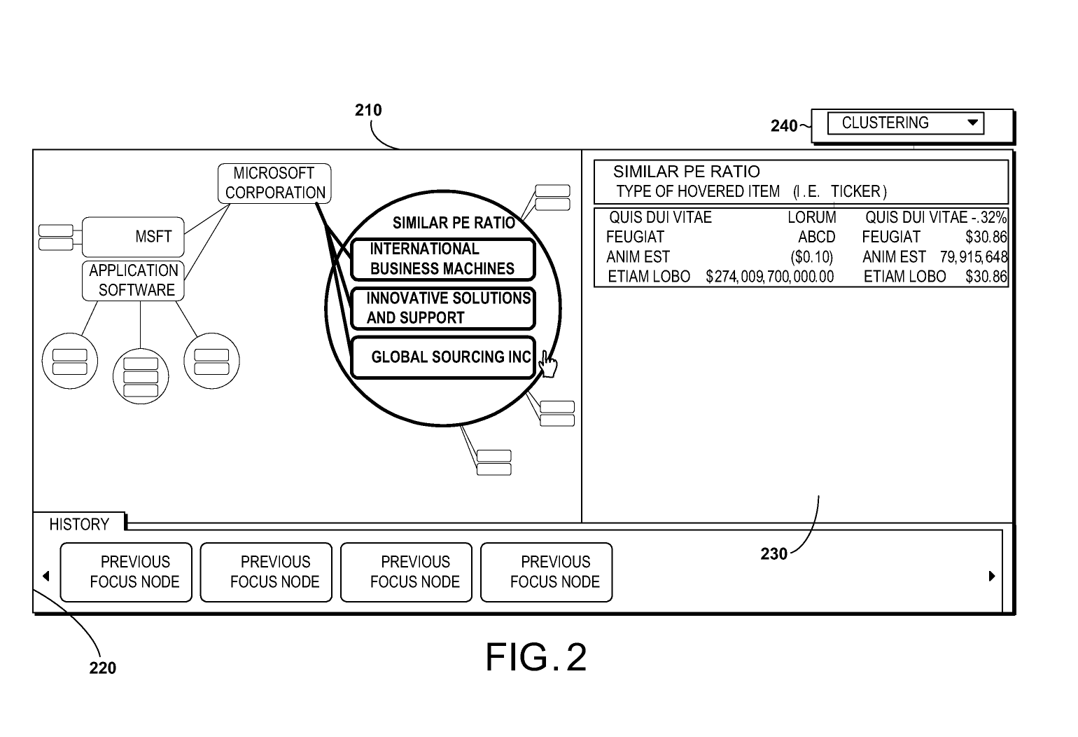

FIG. 2 is a screenshot illustrating a graphical user interface 200 displaying relationships among a query and its corresponding entities in accordance with embodiments of the invention. The graphical user interface 200 includes a graph section 210, a history section 220, a details section 230, and an algorithm dropdown 240.

The graph section 210 displays the relationships among the query and the dominant entities. The graph includes nodes and edges. Some nodes may nest other nodes. For instance, a group of nodes may be included within another node. A user may navigate the graph with a pointer by hovering over nodes or selecting nodes. The graph section 210 is updated by changing focus to the nodes of interest.

The history section allows the user to review the entities traversed during a navigation session. The history section 220 includes the items previously selected or hovered over by the user. The history section 220 may include a thumbnail of the graph and the name of the node that was selected or hovered over. A user may select any thumbnail in the history section to reload that portion of the graph in the graph section 210.

The details section provides attribute information for the dominant entities or the query. The details section 230 is updated to display the attributes of the nodes that are selected or hovered over by the user. The details section 230 displays attribute information extracted for the selected node. For instance, when the user clicks on a node for a company that issues stock, the details section may display the earnings, price-to-earnings ratio, income, etc. which may be extracted from the results provided by the search engine.

The algorithm dropdown 240 displays the algorithms that are applied to select the dominant entities that are displayed in the graph section 210. The algorithm drop-down may provide the user with the option to select entities based on clustering, nearest neighbor, value-based, performance-based, etc. After the user selects the algorithm, the graph section 210 is updated to include additional dominant entities that are identified when the selected algorithm is applied to the results by the computer system.

In some embodiments, the dominant entities are displayed in a graphical user interface to provide an overview of the important topics included in results returned by a search engine in response to a query. The graphical user interface may present a graph that is navigable to view the dominant entities and dominant relationships.

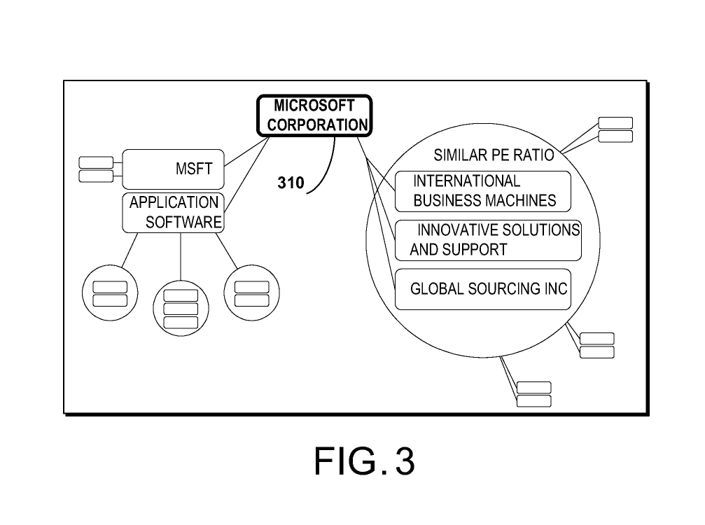

FIG. 3 is a screenshot illustrating a query 310 and its corresponding entities in accordance with embodiments of the invention. The query 310 is represented as a node and may be highlighted to reflect that the focus of the graph is query 310. The dominant entities that are related to the query 310 are connected via edges. The user may select or hover over any of the dominant entities to change focus.

In one embodiment, the edges or dominant entities that connect to the query are selected or hovered over to change focus from the query. The graphical user interface may shift in an appropriate direction to indicate that focus is changing. Moreover, the graphical user interface may highlight the edge or dominant entity selected or hovered over by the user.

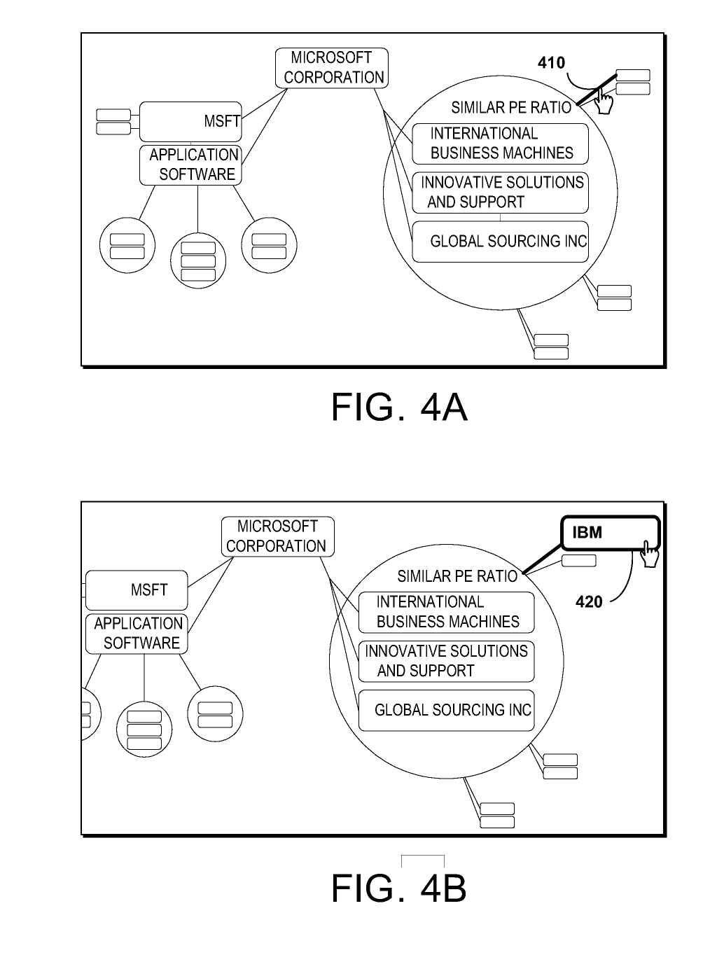

FIGS. 4A and 4B are screenshots illustrating the highlight to edges 410 and nodes 420 that link the entities and query in accordance with embodiments of the invention. FIG. 4A illustrates a change in focus to the edge 410. FIG. 4B illustrates a change in focus to the node 420. When the user selects or hovers over the edge 410, the graphical user interface is updated by highlighting the edge 410 and removing the highlighting from the query. In one embodiment, the highlight may include bold formatting. In another embodiment, the highlight may include any one of: a change in line size, line color, or background color.

When the user selects or hovers over the node 420, the graphical user interface is updated by highlighting the node 420 and removing the highlighting from the query or the previous item that was in focus. In one embodiment, the highlight may include bold formatting. In another embodiment, the highlight may include any one of: a change in font size, font color, or background color of the entity represented by the node 420. As illustrated in FIGS. 4A and 4B, in some embodiments, the change in focus may cause the graph to shift—in any combination of the following directions: right, left, up, or down—to provide additional screen real estate. The additional screen real estate allows the graphical user interface to fully display the selected or hovered-over entity 420.

In certain embodiments, the nodes may be nested to illustrate dominant entities that co-occur. Additionally, the nodes may be nested to maximize use of the available screen real estate. The nested node includes two or more nodes. One outer node and one or more inner nodes. A user may interact with the outer node and the inner nodes.

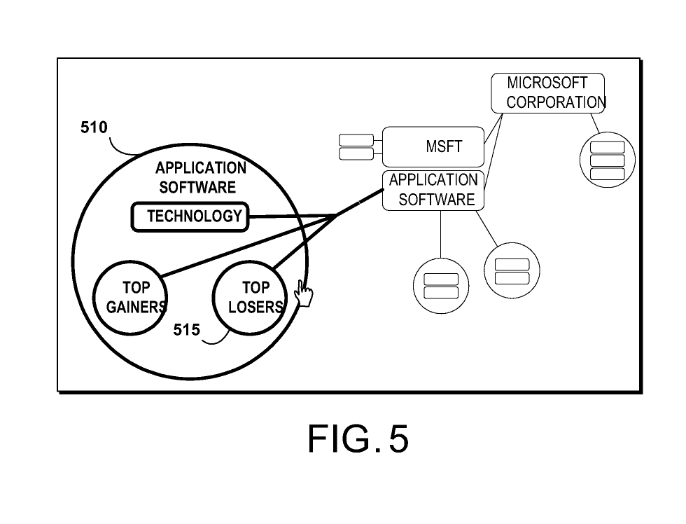

FIG. 5 is another screenshot illustrating a nested node in accordance with embodiments of the invention. The nested node includes an outer node 510 and inner nodes 515. The outer node 510 may identify a relationship between the query and the inner nodes 515. The user may interact with the outer node 510 or the inner nodes 515. In one embodiment, the outer node 510 may be an entity that frequently co-occurs with the entities represented by the inner nodes 515. The entities represented by the inner nodes 515 do not have to co-occur. For instance, “application software” may be an outer node 510 and “technology,” “top gainers,” and “top losers” may be inner nodes 515 of the nested nodes. The “application software” entity may frequently co-occur with “technology,” “top gainers,” and “top losers” within the search results. Thus, the computer system may nest “technology,” “top gainers,” and “top losers” within the “application software” node to conserve screen real estate.

In an embodiment, the graphical user interface is configured to interact with nested nodes. When a user selects or hovers over a nested node, the graphical user interface may be updated to highlight the nested node or an inner node. When the user interacts with an inner node, only the inner node and its corresponding relationships, if any, are highlighted. Alternatively, when the user selects the nested node, the outer and inner nodes are highlighted.

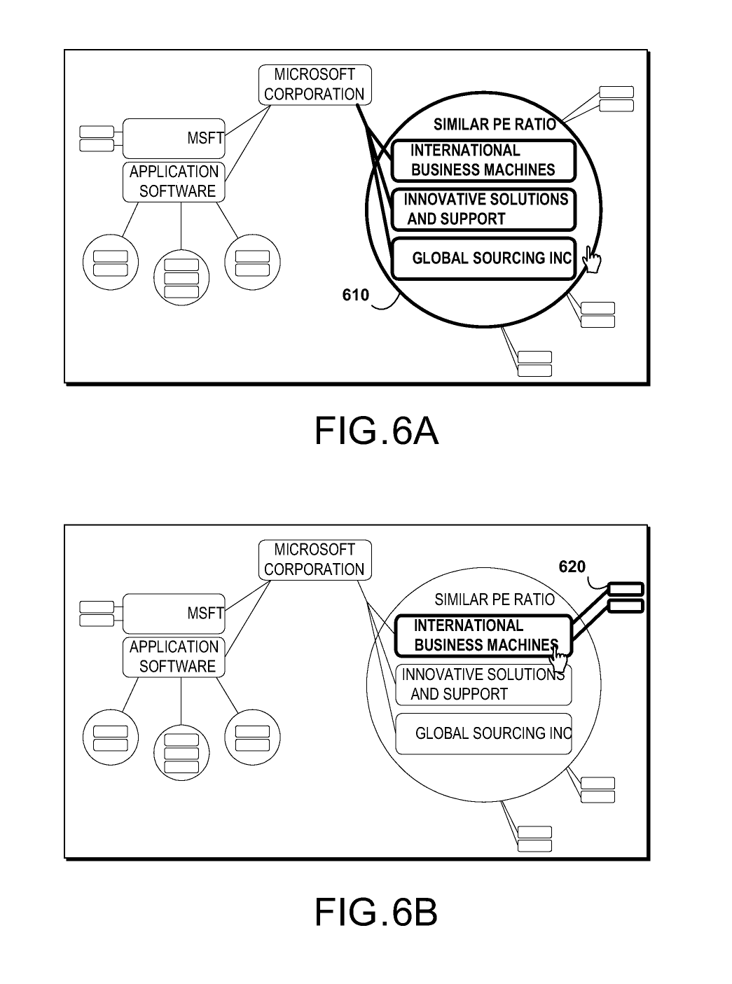

FIGS. 6A and 6B are screenshots illustrating the highlight to nested nodes that link the entities and query in accordance with embodiments of the invention. FIG. 6A illustrates a highlight to the nested node 610. FIG. 6B illustrates a highlight to the inner node 620 of nested node 610. The nested node 610 may be highlighted when the user selects or hovers over the outer node. The graphical user interface highlights the outer node and the nested node to shift focus to the nested node 610. When the user hovers or selects inner node 620, the graphical user interface removes highlights from the nested node 610 and highlights only the inner node 620. In an embodiment, the inner node 620 and any relationships to other nodes may be highlighted by the computer system to shift focus to the inner node 620.

In another embodiment, details for a node may be displayed in the graphical user interface. The details may include attributes that are provided in a details section of the graphical user interface. When a user highlights or hovers over a node, the details section is updated to display information for the node. In an embodiment, the information may be extracted from the search results.

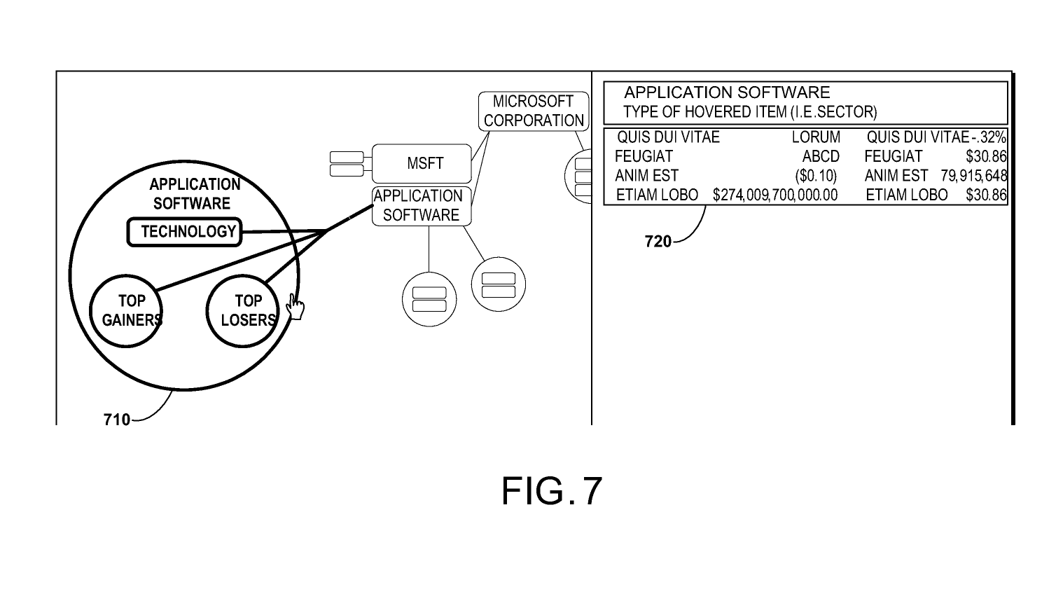

FIG. 7 is another screenshot illustrating a graphical user interface providing details for a selected relationship in accordance with embodiments of the invention. The nested node 710 may be selected or hovered over by the user. The nested node 710 may identify a relationship between the inner nodes and the query. In turn, the graphical user interface is updated to provide information for the nested node 710 in the details section 720. For instance, the “application software” nested node 710 may be selected by the user. The details section 720 is updated by the computer system to include attribute information for the “application software” nested node, which may include software titles, sales, and market share information.

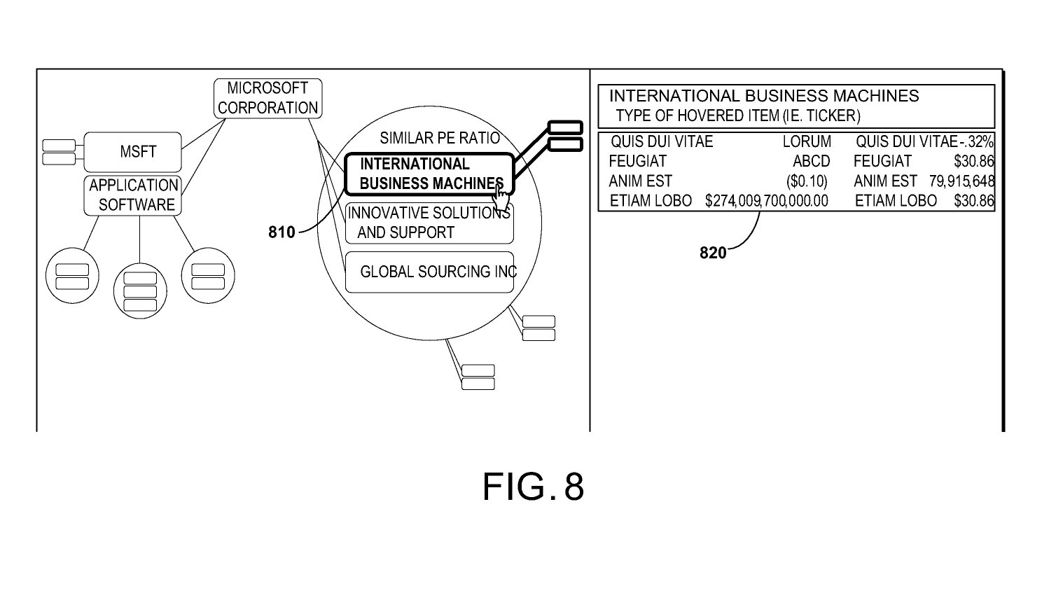

FIG. 8 is another screenshot illustrating a graphical user interface providing details for an inner node 810 of a nested node in accordance with embodiments of the invention. The inner node 810 may be selected or hovered over by the user. The inner node 810 may identify a dominant entity that is related to the query term. In turn, the graphical user interface is updated to provide information for the inner node 810 in the details section 820. For instance, the “International Business Machines” inner node 810 may be selected by the user. The details section 820 is updated by the computer system to include attribute information for the “International Business Machines” nested node, which may include stock price, profit, and price-earnings ratio.

In certain embodiments, the graphical user interface includes a drop-down box that allows the user to view additional entities that are similar to a selected entity. The drop-down box may provide algorithms that may be selected. In turn, the computer system executes the selected algorithm and updates the graphical user interface to display the additional entities that are identified with the selected algorithm.

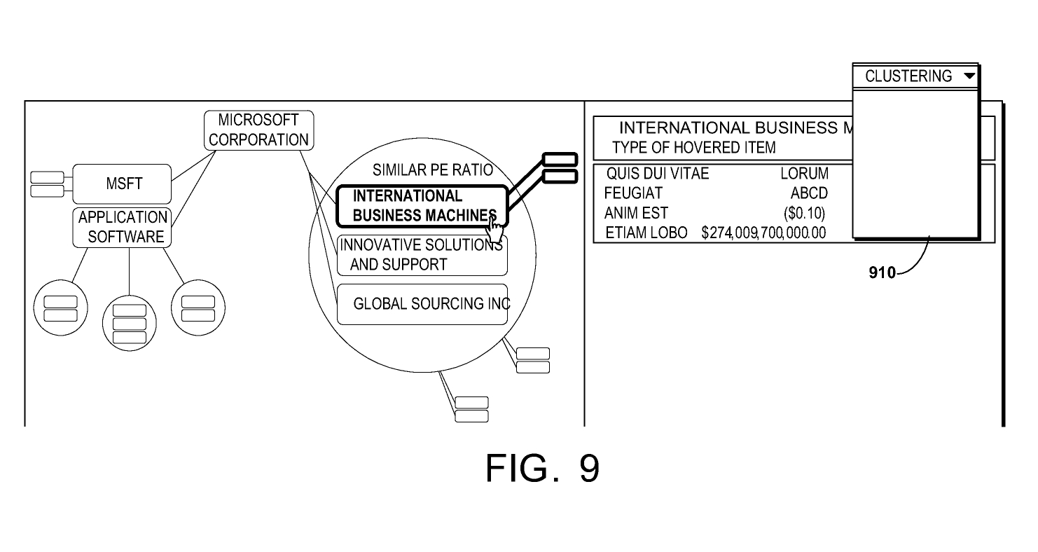

FIG. 9 is another screenshot illustrating a graphical user interface providing a drop-down box 910 to select an algorithm that selects the entities displayed on the graphical user interface in accordance with embodiments of the invention. The drop-down box 910 lists various algorithms that may be used to select additional entities. The algorithms include clustering, nearest neighbor, value based, performance based, etc. The clustering algorithm updates the graphical user interface to include additional entities that are clustered with the selected node. The nearest neighbor algorithm updates the graphical user interface to include additional entities that are neighbors, i.e., sharing similar attributes, to the selected node. The value-based algorithm updates the graphical user interface to include additional entities that have similar numerical values for specified attributes i.e., profits, earnings, etc., as the selected node. The performance-based algorithm updates the graphical user interface to include additional entities that have similar rates of change for specified attributes, i.e., profits, earnings, etc., as the selected node.

In some embodiments, the history pane is displayed at the bottom of the graphical user interface. The history pane includes icons that include a thumbnail or screen shot of the nodes that were previously interacted with by the user. A user may select the icon to display a previously interfaced node. In one embodiment, the history pane is displayed on the graphical user interface when the user requests to view the navigation history for the current session.

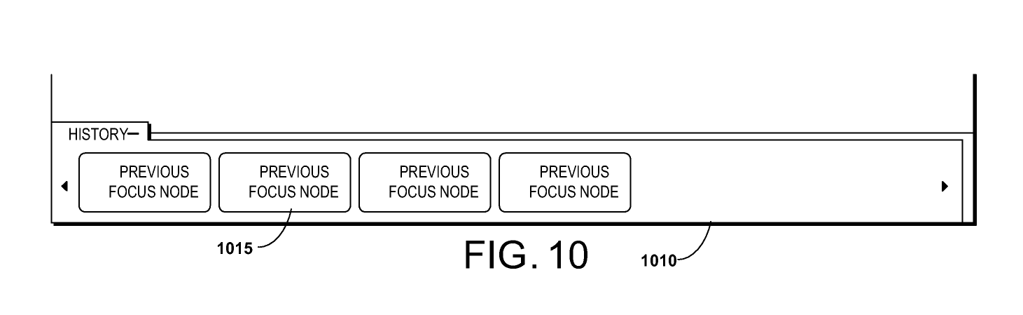

FIG. 10 is another screenshot illustrating a graphical user interface providing a history pane 1010 that displays previously interacted nodes 1015 in accordance with embodiments of the invention. The history pane 1010 is updated when the user causes the computer system to change focus by selecting or hovering over another node. The previously interacted node 1015 is included in the history pane 1010. In one embodiment, the computer system includes a screenshot or a thumbnail of the previously interacted node 1015 as an icon in the history pane 1015. The icon may also include the words that are included in the previously interacted node 1015. When the user clicks on the icon, the graphical user interface refocuses the graphical user interface on the previously interacted node 1015.

In some embodiments, a computer system executes a computer-implemented method to navigate the relationships among entities. Dominant entities are displayed in a graphical user interface generated by a search engine. The dominant entities corresponding to the query may be displayed in a graph to provide an overview of search results for the query. In turn, the graphical user interface is updated based on the interactions with the graph.

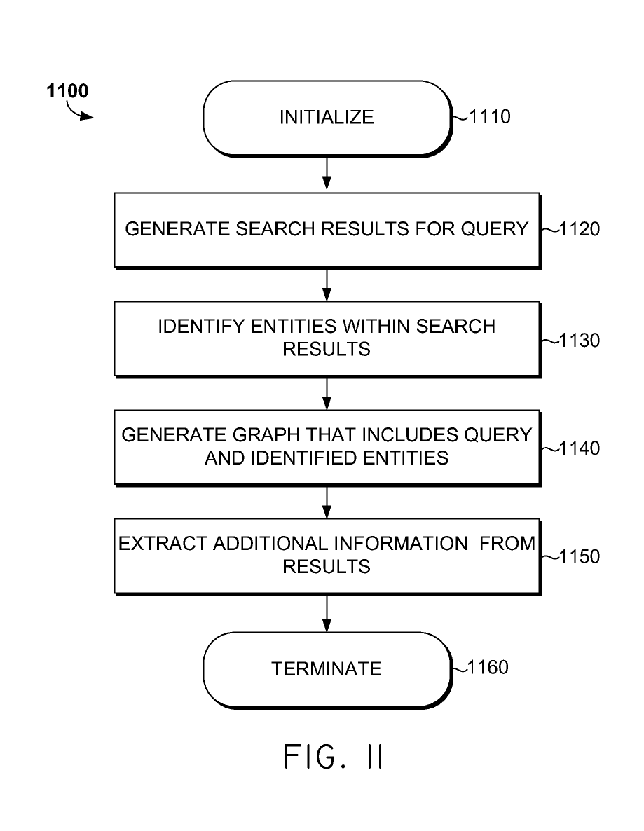

FIG. 11 is a logic diagram illustrating a computer-implemented method for navigating relationship among entities in accordance with embodiments of the invention. The method is initialized in step 1110, when the search engine receives a query. In step 1120, the search results for the query are obtained from the search engine. The search engine generates results by searching multiple sources for items that match the query. The multiple sources include, but are not limited to, video, web, audio, and social networking sources.

In step 1130, the computer system identifies entities within the search results. The entities may be identified based on appearance frequency. In certain embodiments, the entities are any combination of noun, phrase, adjective, or adverb. In turn, a graph that includes the query and identifies entities that correspond to the query is generated by the computer system, in step 1140. The nodes of the graph may represent the query and the identified entities. The edges of the graph connect the nodes. In an embodiment, some nodes in the graph are nested within other nodes. The graph is displayed on a graphical user interface. In an alternative embodiment, the graph is a toolbar configured in a web browser that transmitted the query to the search engine. In yet another embodiment, the relationships selected for display in the graph include entities having appearance frequencies above a specified threshold.

In step 1150, the graph may be traversed to obtain additional information extracted from the results for the selected query or the selected entity. For instance, hovering over the nodes causes a details window to display attributes for the node that is hovered over. The search engine may extract attributes from the results. Moreover, the graphical user interface shifts focus to the hovered-over node. The method terminates in step 1160.

In summary, dominant relationships within results for a query are identified and made navigable by a graph generated by the computer system. The computer system generates a graphical user interface having dominant entities associated with a query. The query is issued to a search engine that searches multiple sources to locate results. The computer system extracts the dominant entities from the results and provides a graph to visualize the relationships between the query and the dominant entities. The computer system obtains additional information for the nodes of the graph as a user interacts with the graph.

Many different arrangements of the various components depicted, as well as components not shown, are possible without departing from the spirit and scope of the present invention. Embodiments of the invention have been described with the intent to be illustrative rather than restrictive. It is understood that certain features and subcombinations are of utility and may be employed without reference to other features and subcombinations and are contemplated within the scope of the claims. Not all steps listed in the various figures need be carried out in the specific order described.

The invention claimed is:

1. A computer implemented method to navigate relationships among entities, the method comprising:
receiving a query;
generating search results for the query;
identifying entities within the search results;
generating a graph that includes the query and entities that correspond to the query, wherein the nodes of the graph represent the query and the entities and edges connect the nodes; and
extracting additional information from the results for the selected query or the selected entity in response to traversal of the graph.

2. The method of claim 1, wherein the results are generated by searching multiple sources for items that match the query.

3. The method of claim 2, wherein the multiple sources include video, web, audio, and social networking sources.

4. The method of claim 1, wherein the entities are identified based on appearance frequency.

5. The method of claim 4, wherein the relationships selected for display include entities having appearance frequencies above a specified threshold.

6. The method of claim 1, wherein the entities are any combination of noun, phrase, adjective, or adverb.

7. The method of claim 6, wherein the nouns, phrases, adjectives or adverbs correspond to the query.

8. The method of claim 1, wherein the graph is displayed on a graphical user interface.

9. The method of claim 8, wherein the graph is displayed on a graphical user interface.

10. The method of claim 8, wherein the graph is a toolbar configured in a web browser that transmitted the query to the search engine.

11. The method of claim 8, wherein hovering over the nodes causes a details window to display attributes for the node that is hovered over.

12. The method of claim 1, wherein the graphical user interface shifts focus to the node that is hovered over.

13. The method of claim 1, wherein some nodes in the graph are nested within other nodes.

14. A graphical user interface generated by a computer system having processors and computer-readable media, wherein the graphical user interface provides controls to navigate relationships and entities, the graphical user interface comprising:
a graph displaying dominant relationships, wherein the graph includes nodes that represent entities and a query, wherein the entities are extracted from results returned by a search engine that received the query;
an algorithm control that allows a user to update the entities displayed for the query; and
a history area that is available to show the user previously selected nodes.

15. The graphical user interface of claim 14, wherein selecting a node causes a window to open and show attributes for the selected node.

16. The graphical user interface of claim 14, wherein hovering over or selecting a node causes a change in focus by moving and formatting the graph to bring attention to the nodes or relationship that is selected or hovered over.

17. The graphical user interface of claim 14, wherein the algorithm control is a drop-down box that includes cluster, value-based, performance-based, and nearest-neighbor operations.

18. The graphical user interface of claim 17, wherein the nearest-neighbor operation provides additional entities that are related to a selected node.

19. One or more computer-readable media storing computer-usable instructions for performing a method to navigate dominant concepts extracted from multiple sources, the method further comprising
receiving a query;
generating search results for the query;
identifying entities within the search results;
generating a graph that includes the query and entities that correspond to the query, wherein the nodes of the graph represent the query and the entities and edges connect the nodes; and
extracting additional information from the results for the selected query or the selected entity when the graph is traversed.
